(19) United States
(12) Patent Application Publication
(10) Pub. No.: US 2010/0295314 A1
(43) Pub. Date: Nov. 25, 2010

(54) Floating wind turbine

(76) Inventor: Chester Sohn, Gig Harbor, WA (US)

Correspondence Address: DAVID AND RAYMOND PATENT FIRM, 108 N. YNEZ AVE., SUITE 128, MONTEREY PARK, CA, 91754, US

(21) Appl. No.: 12/454,613

(22) Filed: May 19, 2009

(51) Int. Cl. F03D 9/00; F03D 9/02

(52) U.S. Cl. 290/55

(57) ABSTRACT

A floating wind turbine includes a floating frame, and at least one wind turbine assembly. The floating frame is adapted for suspendedly traveling in a fluid medium so as to be exposed to a predetermined amount of air flow. The wind turbine assembly includes a rotor hub and a plurality of blades. Each of the blades has a proximal end radially extended from the guiding rim of the rotor rub and a distal end outwardly extending to define a blade surface between the proximal end and the distal end, wherein the surfaces of the blades are arranged in such a manner that when the air flows exerts on the blade surfaces of the blades, the rotor hub is driven to rotate for generating electricity, wherein the rotor hub allows the air flow passing through an air passage to minimize an air drag thereof.

### BACKGROUND OF THE PRESENT INVENTION

1. Field of Invention

The present invention relates to a wind turbine, and more particularly to a floating wind turbine which is capable of suspendedly floating in a fluid medium for being exposed to a predetermined amount of wind for converting mechanical energy into electrical energy.

2. Description of Related Arts

A conventional wind turbine usually comprises a plurality of blades that rotate around a hub, which most commonly revolves around a horizontal axis. The hub is connected to a drive train, which transfers energy to a generator, often via a gearbox. The drive train and gear box are typically located inside a nacelle or housing, which is generally mounted at the top of a tower. The entire structure of a typical wind turbine is usually installed at a particular location on a designated piece of land, such as on top of a small hill.

As a matter of practical application of wind turbine technology, wind turbines are usually built in numerous amount over an extensive area of land. This is because of the limited amount of electrical energy that can be acquired from a single wind turbine unit. As a result, in order to acquire an adequate amount of electrical energy, many wind turbine units must be utilized simultaneously over an extensive area of land.

As one might expect, there exist many disadvantages in association with this type of traditional wind turbines, the most obvious being the requirement of a large area of land. In other words, wind turbines as a means of electricity generators cannot be extensively used for want of a large tract of land. Moreover, since a large tract of land is generally required, this inevitably increases the cost of the generation of the electricity by means of wind turbines. And this often compensates the traditional advantages associated with the use of this kind of electricity generation technology.

Second, when air flows through the turbine, a substantial portion of the flow of air will be bounced back by the hub. As a result, that portion does not contribute to the rotational movement of the turbine. At a given time, much energy which is carried by wind will be lost simply by it not being properly collected. What is worse is that if the energy carried by that portion of wind which impinges on the turbine but is not properly converted into kinetic energy of the hub and the blade, the excess energy will actually cause air drag and retard the rotational movement of the wind turbine, thereby significantly reducing an efficiency thereof.

In other words, when one is using tradition wind turbine technology to generate electricity, he or she is confronted with the requirement of a large area of land and huge loss of energy due to the inefficiency of a typical conventional wind turbine. These make wind turbines as a means of generating electricity extremely unattractive, especially in areas where land is a sort of extremely scarce natural resource.

### SUMMARY OF THE PRESENT INVENTION

A main object of the present invention is to provide a floating wind turbine which is capable of suspendedly floating in a fluid medium for being exposed to a predetermined amount of wind for converting mechanical energy into electrical energy.

Another object of the present invention is to provide a floating wind turbine which is arranged to operate in a fluid medium so that the present invention does not occupy a substantial area of land when operating. In other words, the present invention substantially overcomes the disadvantages associated with conventional wind turbines.

Another object of the present invention is to provide a floating wind turbine which is capable of effectively and efficiently converting mechanical energy into electrically energy with minimum energy loss which results from inherent structural design of traditional wind turbines.

Another object of the present invention is to provide a floating wind turbine which does not involve complicated and expensive mechanical or electrical components so as to minimize the manufacturing and running cost of the present invention.

Accordingly, the present invention provides a floating wind turbine, comprising:

a floating frame adapted for suspendedly traveling in a fluid medium so as to be exposed to a predetermined amount of air flow; and

at least one wind turbine assembly which is operatively mounted on the floating frame, and comprises:

a rotor hub having a peripheral guiding rim and an air passage formed within the guiding rim for allowing an axial flow of air passing through the air passage of the rotor hub; and

a plurality of blades, each of the blades having a proximal end radially extended from the guiding rim of the rotor rub and a distal end outwardly extending to define a blade surface between the proximal end and the distal end, wherein the surfaces of the blades are arranged in such a manner that when the air flows exerts on the blade surfaces of the blades, the rotor hub is driven to rotate for generating electricity, wherein the rotor hub allows the air flow passing through the air passage to minimize an air drag thereof so as to enhance an efficiency of the rotational power generated by the rotor hub.

Moreover, the present invention also provides a method of generating electricity by using a floating wind turbine comprising a floating frame and at least one wind turbine assembly, comprising the steps of:

(a) floating the floating frame and the wind turbine assembly into a predetermined medium of fluid;

(b) allowing the wind turbine assembly to be exposed to a predetermined amount of air flow;

(c) converting mechanical energy from the air flow into electrical energy by the wind turbine assembly while the floating frame floats in the medium of fluid; and

(d) storing the converted electricity energy in an energy storage provided on the floating frame for future use.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a floating wind turbine according to a preferred embodiment of the present invention.

FIG. 2 is an alternative mode of the floating wind turbine according to the above preferred embodiment of the present invention.

FIG. 3 is a method of generating electricity by a floating wind turbine according to the above preferred embodiment of the present invention.

### DETAILED DESCRIPTION OF THE PREFERRED EMBODIMENT

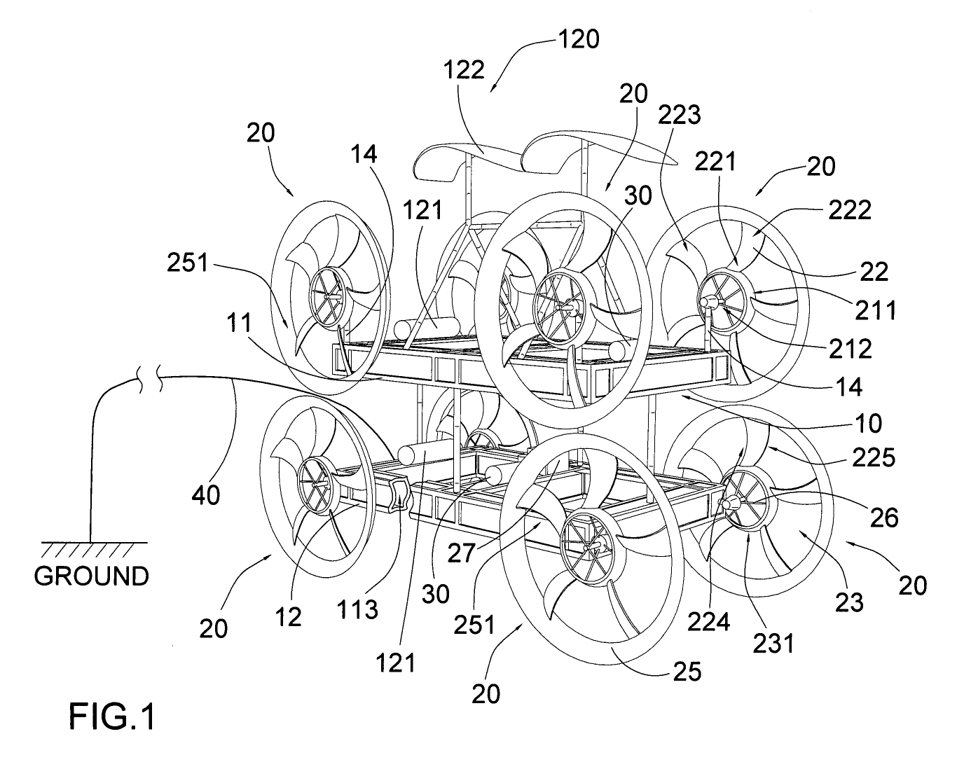

Referring to FIG. 1 of the drawings, a floating wind turbine according to a preferred embodiment of the present invention is illustrated, in which the floating wind turbine comprises a floating frame 10, and at least one (but preferably a plurality of) wind turbine assembly 20.

The floating frame 10 is adapted for suspendedly traveling in a fluid medium, such as air or water so as to be exposed to a predetermined amount of air flow.

Each of the wind turbine assemblies 20 is operatively mounted on said floating frame 10, and comprises a rotor hub 21 and a plurality of blades 22. The rotor hub 21 has a peripheral guiding rim 211 and an air passage 212 formed within the guiding rim 211 for allowing an axial flow of air passing through the air passage 212 of the rotor hub 21.

Each of the plurality of blades 22 has a proximal end 221 radially extended from the guiding rim 211 of the rotor rub 21, and a distal end 222 outwardly extending to define a blade surface 223 between the proximal end 221 and the distal end 222, wherein the blade surfaces 223 of the blades 22 are arranged in such a manner that when the air flows exerts on the blade surfaces 223 of the blades 22, the rotor hub 21 is driven to rotate for generating electricity, wherein the rotor hub 21 allows the air flow passing through the air passage 212 to minimize an air drag thereof so as to enhance an efficiency of the rotational power generated by the rotor hub 21.

According to the preferred embodiment of the present invention, the floating frame 10 comprises a first frame body 11 and a floating device 120 mounted on the frame body 11 for allowing the frame body 11 to conveniently travel in a predetermined medium of fluid, which according to the preferred embodiment of the present invention, is air.

As shown in FIG. 1 of the drawings, the frame body 11 has a rectangular cross section wherein the floating device 120 is provided on the frame body 11 for assisting the frame body 11 to travel smoothly and effectively in the corresponding fluid medium. The floating wind turbine preferably comprises four wind turbine assemblies 20 provided at four corner portions of the frame body 11 for being exposed to the air flow so as to generate electricity. In order to allow the frame body to float on a predetermined fluid medium, the frame body 11 has a receiving cavity 113 formed thereon wherein the floating device 120 comprises a hydrogen generator 121 mounted on the frame body 11 and arranged to supply a predetermined volume of hydrogen into the receiving cavity 113. The hydrogen then provides the necessary up-thrusting force to allow the frame body 11 to float on the predetermined fluid medium, such as air.

For each of the wind turbine assemblies, the guiding rim 211 is shaped and sized to extend from the rotor hub 21 to the blade surfaces 223 of the blades 22 in such a manner that when the air passes through the rotor hub 21, it will be guided by the guiding rim 211 to travel therealong and when the air is has been guided to flow through the blade surfaces 223, it provides additional power for rotating the blades 22 so as to enhance an efficiency of the corresponding wind turbine assembly 20 in converting wind's kinetic energy to the rotational power of the wind turbine assembly 20.

The rotor hub 20 further comprises an air guider 23 provided on the guiding rim 211 to form an air detouring surface 231 on the guiding rim 211 for guiding the air flowing towards the blade surface 223 of each of the blades 22 when the air flow impinges on the rotor hub 20 so as to provide additional wind power to the blade 23 for rotating the corresponding wind turbine assembly 20.

Each of the blades 22 has the leading edge 224 that is curved for minimizing turbulence when the blade 22 slices into the flow of air, and a trailing edge 225 having a tapered contour extending between the distal end 222 of the blade 22 to the proximal end 221 thereof, such that when the air hits on the blade 22, the blade 22 is efficiently driven to rotate for converting an kinetic energy of the flow of air to the rotational power of the wind turbine assembly.

The wind turbine assembly may further comprise a plurality of hinges connecting the rotor hub 20 with the proximal ends 221 of blades 22 respectively in a retractably rotating manner to allow a blade angle of each of the blades 22 to be adjustably changed with respect to a direction of the air flow, so as to regulate a rotational speed of the rotor hub 20.

Moreover, each of the wind turbine assemblies 20 further comprises an outer retention frame 25 connecting to the distal ends 222 of the blades 22, wherein the outer retention frame 25 has an air guiding surface 251 extended towards the distal ends 222 of the blades 22 for guiding the air flowing towards the blade surface 222 of each of the blades 22 when the air flow impinges on the retention frame 25 so as to provide additional wind power to the blade 22 for rotating the corresponding wind turbine assembly 20.

Each of the wind turbine assemblies further comprises a power generator 27 supported by the floating frame 10 and is rotatably coupled with the corresponding rotor hub 20, wherein the power generator 27 is arranged to generate electrical energy from the mechanical energy provided by the rotational movement of the rotor hub 20. More specifically, the rotor hub 20 has a ring shape which defines the air passage 212 therewithin, and comprises a plurality of spokes 26 spacedly extended from the guiding rim 211 to rotatably couple with the corresponding power generator 27. As such, the mechanical movement driven by the air flow will be converted into electrical energy through the power generator 27.

Since the floating wind turbine is adapted to float or travel in a medium of fluid, such as in the air, the electricity generated by each of the power generators 27 can be stored in a predetermined energy storage 30 provided on the floating frame 10 so that when the floating frame 10 stops traveling in the fluid medium, a user is able collect the electrical energy stored in the energy storage 30 for future use.

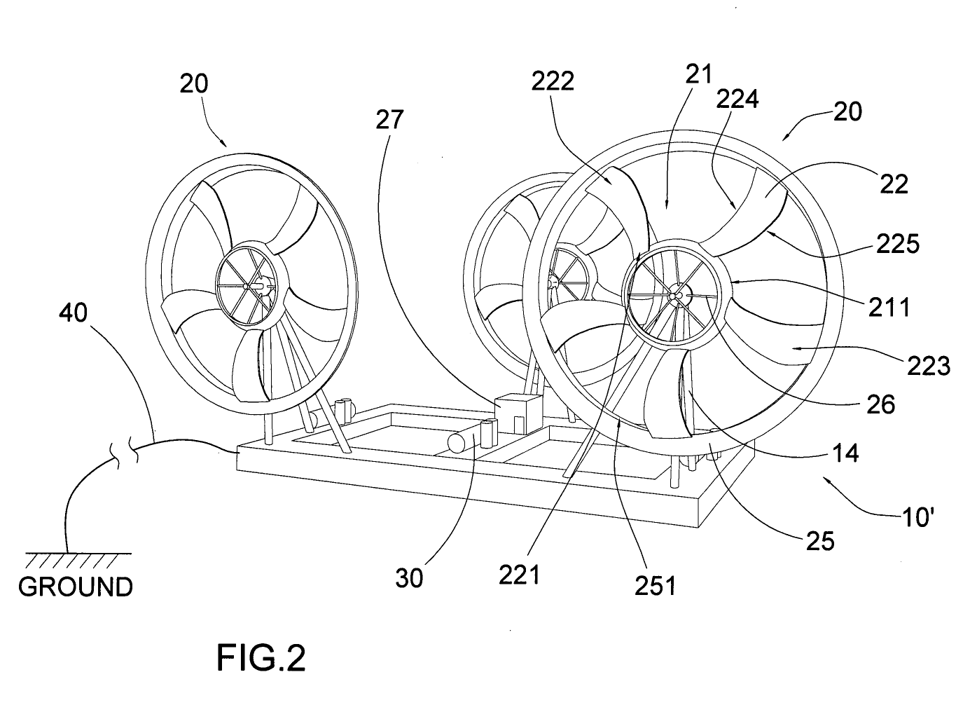

The floating wind turbine further comprises a connecting cable 40 extended from the floating frame 10 for restraining a movement thereof. The connecting cable 40, having a predetermined length, is used for restricting the movement of the floating frame 10 so that when it is traveling in the medium of fluid (such as air), a user is able to loosely control the movement of the floating frame 10 and to collect the floating frame 10 from the medium of fluid. Furthermore, the connecting cable 40 may also be embodied as an electrical cable so that the power generated by the power generator 27 or stored in the energy storage 30 can be simultaneously transmitted back a predetermined location through the connecting cable 40. For example, when the floating frame is traveling in air, the electrical power generated by the power generator 27 can be transmitted to the ground to be used via the connecting cable 40, as shown in FIG. 1 and FIG. 2 of the drawings.

Referring to FIG. 1 of the drawings, the floating frame 10 further comprises a second frame body 12 spacedly provided from the first frame body 11 for forming a double layer frame structure of the floating frame 10, wherein the wind turbine assemblies 20 are spacedly provided on four corners portions of each of the first frame body 11 and the second frame body 12. According to the preferred embodiment of the present invention, the first frame body 11 is identical to the second frame body 12, so that an identical number of wind turbine assemblies 20 can also be mounted onto the second frame body 12.

In order to securely yet rotatably mount the wind turbine assemblies 20 onto the first and the second frame body 11, 12, the floating frame 10 further comprises a plurality of mounting frames 14 provided on the first and the second frame body 11, 12 wherein the rotor hubs of the wind turbine assemblies 20 are rotatably mounted on the mounting frames 14 respectively. It is worth mentioning that the mounting frames 14 are arranged to rotatably support the wind turbine assemblies 20 at an elevated position so as to allow the wind turbine assemblies 20 to be subject to air flow to the maximum extent. In order to allow better floating performance, the floating frame 10 is made of light-weight material so as to maximize a floating ability thereof in the medium of fluid.

When the floating frame 10 is subject to fluid flow, the floating frame 10 may be blown to have unstable and unpredictable orientation. For example, the floating frame 10 may be pushed to rotate 90 degrees so that the entire floating frame 10 “lies down” in the fluid medium. This will substantially affect the efficiency and effectiveness of energy conversion process. As a result, the floating device 120 further comprises a plurality of wing member 122 provided on the first frame body 11, wherein each of the wing members 122 is aerodynamically designed to stabilize the floating of the frame body 11 when the floating frame 10 is subject to air flow, so that when the floating frame is subject to fluid flow, the floating frame 10 is substantially retained in an orientation having the most effective and efficient energy conversion process. It is also worth mentioning that the wing members 122 are also aerodynamically designed to assist floating of the floating frame 10 and the turbine assemblies 20.

Note also that each of the mounting frames 14 is arranged to be selectively movable with respect to the floating frame 10 so that when the floating frame 10 is subject to very strong wind, the turbine assemblies can be adjusted to tilt at a predetermined angle so as to prevent the corresponding wind turbine assembly 20 from being destroyed or damaged by wind energy. In other words, the mounting frames 14 allow flowing wind to pass through over the top of the wind turbine assemblies 20 so as to reduce the amount of wind energy sustained by the wind turbine assemblies 20.

Accordingly, one skilled in the art would have appreciated from the above disclosure that since the floating frame 10 and the wind turbine assemblies 20 are traveling in the air when operating to convert air flow into electrical energy, there is no need for users of the present invention to designate a large area of land to accommodate the floating frame 10. Rather, the present invention effectively utilizes potentially infinite air space as substitute of scarce and expensive land space.

Referring to FIG. 2 of the drawings, an alternative mode of the floating wind turbine according to the preferred embodiment of the present invention is illustrated. The alternative mode is similar to the preferred embodiment except the floating frame 10′. According to the alternative mode, the floating frame 10′ is adapted for floating on a liquid fluid, such as water, wherein the energy storage 30 and the wind turbine assemblies 20 are spacedly provided on the floating frame 10′. More specifically, the floating frame 10′ has a rectangular cross section and a plurality of spaces 11′ formed thereon to minimize the weight of the floating frame 10′ so as to allow the floating frame 10′ to conveniently and easily flow on the predetermined medium of fluid, which is water in this particular alternative mode.

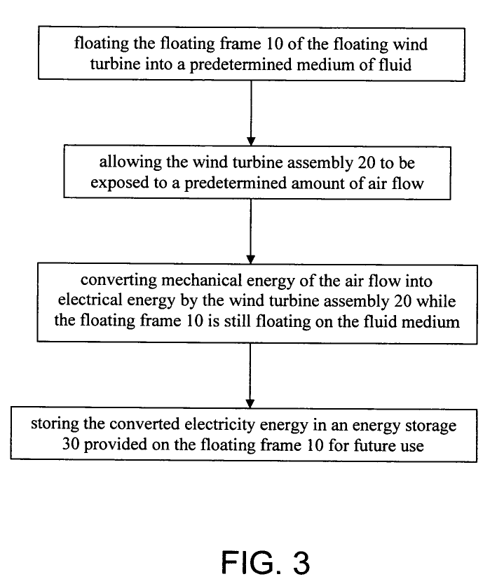

Referring to FIG. 3 of the drawings, a method of generating electricity by using a floating wind turbine comprising a floating frame 10 and at least one wind turbine assembly 20 according to the preferred embodiment is illustrated, in which the method comprises the steps of:

(a) floating the floating frame 10 of the floating wind turbine into a predetermined medium of fluid;

(b) allowing the wind turbine assembly 20 to be exposed to a predetermined amount of air flow;

(c) converting mechanical energy of the air flow into electrical energy by the wind turbine assembly 20 while the floating frame 10 is still floating on the fluid medium; and

(d) storing the converted electricity energy in an energy storage 30 provided on the floating frame 10 for future use.

Step (a) comprises the steps of:

(a.1) providing a hydrogen generator 121 on the floating frame 10 having a receiving cavity 113; and

(a.2) injecting a predetermined volume of hydrogen 121 in the receiving cavity 113 to establish an up-thrusting force for floating the floating frame 10 into the predetermined medium of fluid.

Step (b) comprises the steps of:

(b.1) allowing the wind turbine assembly to normally face toward the air flow so as to initial mechanical movement of the wind turbine assembly; and

(b.2) stabilizing the floating frame by a plurality of wind member 122 so that when the floating frame 10 is subject to air flow, the floating frame 10 is substantially retained in an orientation having the most effective and efficient energy conversion.

After collection and storage of the electrical energy, the method further comprises a step (e) of collecting the floating frame from the medium of fluid so as to retrieve the stored electrical energy for other uses.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A floating wind turbine, comprising:
a floating frame adapted for suspendedly traveling in a fluid medium so as to be exposed to a predetermined amount of air flow; and
at least one wind turbine assembly which is operatively mounted on said floating frame, and comprises:
a rotor hub having a peripheral guiding rim and an air passage formed within said guiding rim for allowing an axial flow of air passing through said air passage of said rotor hub; and
a plurality of blades, each of said blades having a proximal end radially extended from said guiding rim of said rotor rub and a distal end outwardly extending to define a blade surface between said proximal end and said distal end, wherein said surfaces of said blades are arranged in such a manner that when said air flows exerts on said blade surfaces of said blades, said rotor hub is driven to rotate for generating electricity, wherein said rotor hub allows said air flow passing through said air passage to minimize an air drag thereof so as to enhance an efficiency of said rotational power generated by said rotor hub.

2. The floating wind turbine, as recited in claim 1, wherein said floating frame comprises a first frame body and a floating device mounted on said first frame body for allowing said first frame body to conveniently travel in a predetermined medium of fluid, wherein said floating device is upwardly extended from said first frame body for also being exposed to said air flow so as to assist said first frame body to travel smoothly and effectively in said corresponding fluid medium.

3. The floating wind turbine, as recited in claim 2, said floating frame defines a receiving cavity on said first frame body, and comprises a hydrogen generator for supply a predetermined amount of hydrogen within said receiving cavity so as to create an up-thrust force for floating said floating frame into said medium of fluid.

4. The floating wind turbine, as recited in claim 3, wherein said floating device comprises a plurality of wing members provided on said first frame body, wherein each of said wing members is aerodynamically designed to stabilize an orientation of said floating frame floating in said medium of fluid so as to effective and efficient conversion of mechanical energy into electrical energy.

5. The floating wind turbine, as recited in claim 4, wherein for each of said wind turbine assemblies, said guiding rim is shaped and sized to extend from said rotor hub to said blade surfaces of said corresponding blade in such a manner that when said air passes through said rotor hub, said air is guided by said guiding rim to travel therealong and when said air is guided to flow through said blade surfaces, said air provides additional power for rotating said blades so as to enhance an efficiency of said corresponding wind turbine assembly.

6. The floating wind turbine, as recited in claim 5, wherein said rotor hub further comprises an air guider provided on said guiding rim to form an air detouring surface on said guiding rim for guiding said air flowing towards said blade surface of each of said blades when said air flow impinges on said rotor hub so as to provide additional wind power to said blade for rotating said corresponding wind turbine assembly.

7. The floating wind turbine, as recited in claim 4, wherein each of said wind turbine assemblies further comprises an outer retention frame connecting to said distal ends of said blades, wherein said outer retention frame has an air guiding surface extended towards said distal ends of said blades for guiding said air flowing towards said blade surface of each of said blades when said air flow impinges on said retention frame so as to provide additional wind power to said blade for rotating said corresponding wind turbine assembly.

8. The floating wind turbine, as recited in claim 6, wherein each of said wind turbine assemblies further comprises an outer retention frame connecting to said distal ends of said blades, wherein said outer retention frame has an air guiding surface extended towards said distal ends of said blades for guiding said air flowing towards said blade surface of each of said blades when said air flow impinges on said retention frame so as to provide additional wind power to said blade for rotating said corresponding wind turbine assembly.

9. The floating wind turbine, as recited in claim 6, wherein each of said wind turbine assemblies further comprises a power generator supported by said floating frame and is rotatably coupled with said corresponding rotor hub, wherein said power generator is arranged to generate electrical energy from mechanical energy provided by said rotational movement of said rotor hub.

10. The floating wind turbine, as recited in claim 8, wherein each of said wind turbine assemblies further comprises a power generator supported by said floating frame and is rotatably coupled with said corresponding rotor hub, wherein said power generator is arranged to generate electrical energy from mechanical energy provided by said rotational movement of said rotor hub.

11. The floating wind turbine, as recited in claim 8, wherein said wind turbine assembly further comprises an energy storage provided on said floating frame for storing electricity generated by said power generators when said floating frame travels in said medium of fluid.

12. The floating wind turbine, as recited in claim 10, wherein said wind turbine assembly further comprises an energy storage provided on said floating frame for storing electricity generated by said power generators when said floating frame travels in said medium of fluid.

13. The floating wind turbine, as recited in claim 10, wherein said rotor hub has a ring shape which defines said air passage therewithin, and comprises a plurality of spokes spacedly extended from said guiding rim to rotatably couple with said corresponding power generator.

14. The floating wind turbine, as recited in claim 12, wherein said rotor hub has a ring shape which defines said air passage therewithin, and comprises a plurality of spokes spacedly extended from said guiding rim to rotatably couple with said corresponding power generator.

15. The floating wind turbine, as recited in claim 10, further comprising a connecting cable, having a predetermined length, extended from said floating frame for restraining a movement thereof.

16. The floating wind turbine, as recited in claim 14, further comprising a connecting cable, having a predetermined length, extended from said floating frame for restraining a movement thereof.

17. The floating wind turbine, as recited in claim 4, wherein said floating frame further comprises a second frame body spacedly provided from said first frame body for forming a double layer frame structure of said floating frame, wherein said floating wind turbine further comprises a plurality of additional wind turbine assemblies spacedly provided on said first frame body and said second frame body respectively.

18. The floating wind turbine, as recited in claim 16, wherein said floating frame further comprises a second frame body spacedly provided from said first frame body for forming a double layer frame structure of said floating frame, wherein said floating wind turbine further comprises a plurality of additional wind turbine assemblies spacedly provided on said first frame body and said second frame body respectively.

19. The floating wind turbine, as recited in claim 17, wherein said floating frame further comprises a plurality of mounting frames movably provided on said first and said second frame body wherein said rotor hubs of said wind turbine assemblies are rotatably mounted on said mounting frames respectively.

20. The floating wind turbine, as recited in claim 18, wherein said floating frame further comprises a plurality of mounting frames movably provided on said first and said second frame body wherein said rotor hubs of said wind turbine assemblies are rotatably mounted on said mounting frames respectively.

21. A method of generating electricity by using a floating wind turbine comprising a floating frame and at least one wind turbine assembly, comprising the steps of:
(a) floating said floating frame and said wind turbine assembly into a predetermined medium of fluid;
(b) allowing said wind turbine assembly to be exposed to a predetermined amount of air flow;
(c) converting mechanical energy from said air flow into electrical energy by said wind turbine assembly while said floating frame floats in said medium of fluid; and
(d) storing said converted electricity energy in an energy storage provided on said floating frame for future use.

22. The method, as recited in claim 21, wherein said step (a) comprises the steps of:
(a.1) providing hydrogen generator on said floating frame having a receiving cavity; and
(a.2) injecting a predetermined volume of hydrogen in said receiving cavity bys said hydrogen generator to establish an up-thrusting force for floating said floating frame into said predetermined medium of fluid.

23. The method, as recited in claim 21, wherein said step (b) comprises the steps of:
(b.1) allowing said wind turbine assembly to normally face toward said air flow so as to initiate mechanical movement of said wind turbine assembly; and
(b.2) stabilizing said floating frame by a plurality of wind members so that when said floating frame is subject to air flow, said floating frame is substantially retained in an orientation having the most effective and efficient energy conversion.

24. The method, as recited in claim 22, wherein said step (b) comprises the steps of:
(b.1) allowing said wind turbine assembly to normally face toward said air flow so as to initiate mechanical movement of said wind turbine assembly; and
(b.2) stabilizing said floating frame by a plurality of wind members so that when said floating frame is subject to air flow, said floating frame is substantially retained in an orientation having the most effective and efficient energy conversion

25. The method, as recited in claim 21, further comprising a step (e) of collecting said floating frame from the medium of fluid so as to retrieve said stored electrical energy for other uses.

26. The method, as recited in claim 22, further comprising a step (e) of collecting said floating frame from the medium of fluid so as to retrieve said stored electrical energy for other uses.

27. The method, as recited in claim 24, further comprising a step (e) of collecting said floating frame from the medium of fluid so as to retrieve said stored electrical energy for other uses.
